(19) United States
(12) Patent Application Publication
(10) Pub. No.: US 2011/0117777 A1
(43) Pub. Date: May 19, 2011

(54) CABLE CONNECTOR

(75) Inventors: Charles Thomas, Athens, PA (US); Michael Dean, Waverly, NY (US); Timothy Noel Tremba, Cayuta, NY (US)

(73) Assignee: THOMAS & BETTS INTERNATIONAL, INC., Wilmington, DE (US)

(21) Appl. No.: 12/913,068

(22) Filed: Oct. 27, 2010

Related U.S. Application Data
(60) Provisional application No. 61/261,505, filed on Nov. 16, 2009.

(51) Int. Cl. H01R 9/05

(52) U.S. Cl. 439/578

(57) ABSTRACT

A coaxial cable connector may include a connector body having a forward end and a rearward cable receiving end for receiving a cable, a nut rotatably coupled to the forward end of the connector body, and an annular post disposed within the connector body, the annular post including an inner chamber extending axially therethrough and a first barb and a second barb. The cable connector may also include a locking sleeve including a chamber extending therethrough, a first end coupled to the connector body, a second end for receiving the cable, and at least one tooth. The locking sleeve may be configured so that when the locking sleeve is moved axially into the connector body, the at least one tooth is configured to compress the cable between the first barb and the second barb.

### RELATED APPLICATIONS

This non-provisional patent application claims the benefit of U.S. Provisional Patent Application No. 61/261,505, filed Nov. 16, 2010, titled “Cable Connector,” which is hereby incorporated herein.

### BACKGROUND OF THE INVENTION

Embodiments disclosed herein relate to cable connectors and, in some cases, coaxial cable connectors. Such connectors are used to connect coaxial cables to various electronic devices, such as televisions, antennas, set-top boxes, satellite television receivers, etc. A coaxial cable connector may include a connector body for accommodating a coaxial cable, and a nut coupled to the body to mechanically attach the connector to an external device.

### BRIEF DESCRIPTION OF THE DRAWINGS

FIG. 1A is a three-dimensional drawing of an exemplary coaxial cable connector in an assembled configuration;

FIG. 1B is a drawing of a coaxial cable having been prepared to be inserted into and terminated by a coaxial cable connector, such as the coaxial cable connector of FIG. 1;

FIG. 1C is a cross-sectional drawing of an exemplary rear portion of the coaxial cable connector of FIG. 1A in an unattached configuration;

FIGS. 1D and 1E are cross-sectional drawings of an exemplary forward portion of the coaxial cable connector of FIG. 1A in which the coaxial cable of FIG. 1B has been secured;

FIG. 1F is a cross-sectional drawing of a port connector to which the coaxial cable connector of FIG. 1 may be connected;

FIG. 2 is an exploded cross-sectional drawing of unassembled components of an exemplary coaxial cable connector;

FIG. 3 is a cross-sectional drawing of the coaxial cable connector of FIG. 2 in an assembled, but unconnected configuration;

FIG. 4 is a cross-sectional drawing of the connector body of the coaxial cable connector of FIGS. 2 and 3;

FIG. 5 is a cross-sectional drawing of the post of the coaxial cable connector of FIGS. 2 and 3;

FIG. 6 is a cross-sectional drawing of the nut of the coaxial cable connector of FIGS. 2 and 3;

FIGS. 7A and 7B are cross-sectional drawings of the connector body, the post, and the nut of the coaxial cable connector of FIGS. 2 and 3;

FIG. 8 is a cross-sectional drawing of the locking sleeve of the coaxial cable connector of FIGS. 2 and 3;

FIGS. 9A and 9B are cross-sectional drawings of the connector body and the locking sleeve of the coaxial cable connector of FIGS. 2 and 3;

FIG. 10 is a cross-sectional drawing of the coaxial cable connector of FIGS. 2 and 3 in a locked configuration;

FIG. 11 is a cross-sectional drawing of the connector body and locking sleeve of the coaxial cable connector of FIGS. 2 and 3 in a locked configuration; and

FIG. 12 is a cross-sectional drawing of the connector body, locking sleeve, and the post of the coaxial cable connector of FIGS. 2 and 3 in a locked configuration.

### DETAILED DESCRIPTION OF THE PREFERRED EMBODIMENTS

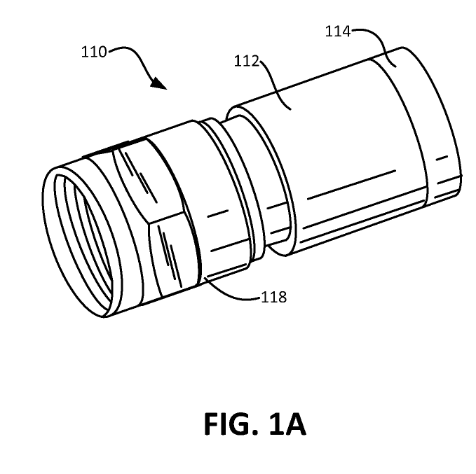

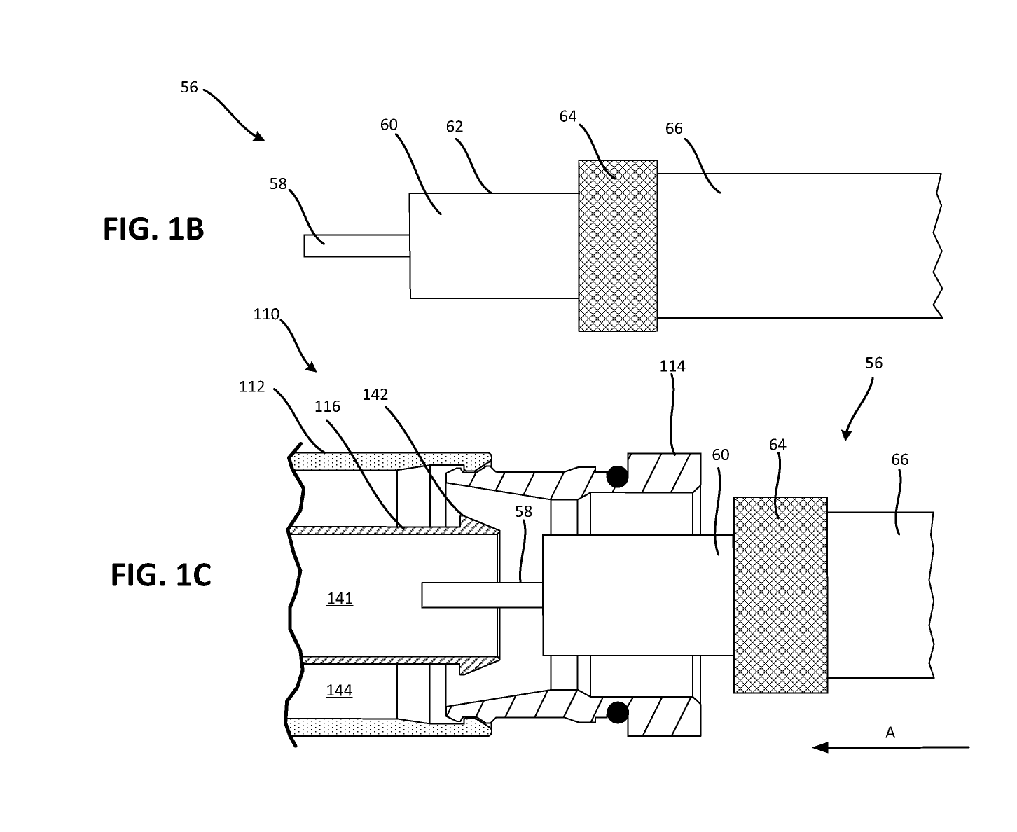

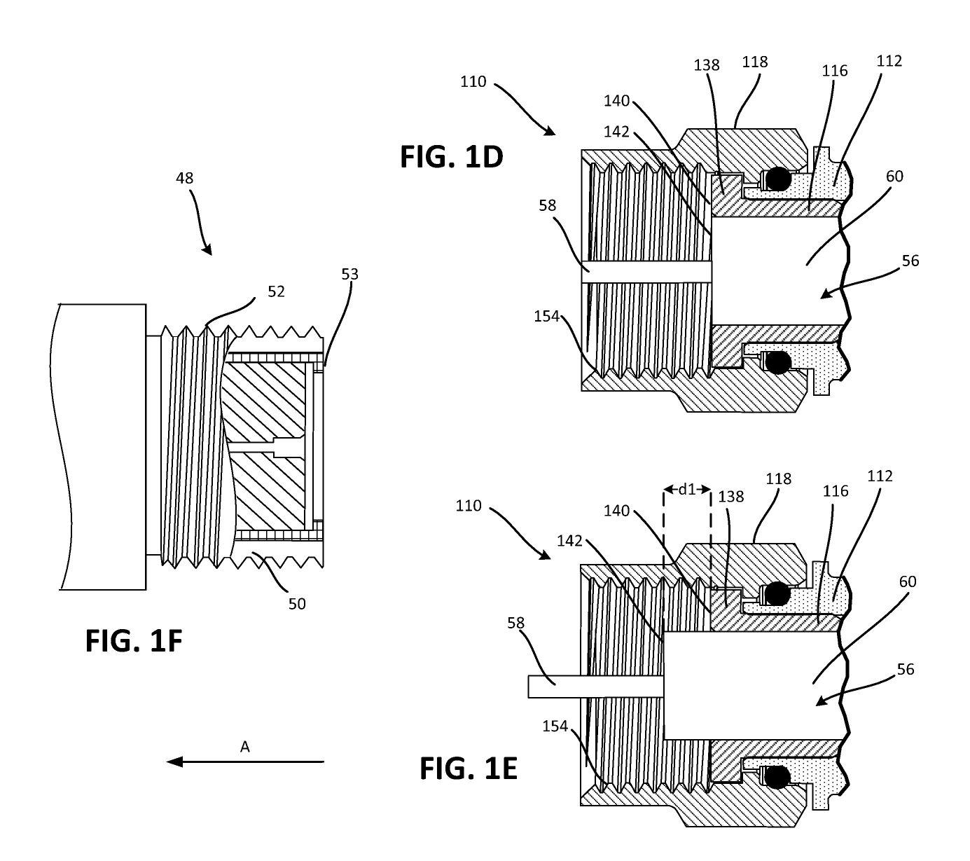

FIG. 1A is a three-dimensional drawing of an exemplary coaxial cable connector 110 in an assembled configuration. As illustrated in FIG. 1A, connector 110 may include a connector body 112, a locking sleeve 114, and a rotatable nut 118. FIG. 1B is a drawing of a coaxial cable 56 having been prepared to be inserted into and terminated by a coaxial cable connector, such as connector 110. Coaxial cable 56 includes a center conductor 58 surrounded by a dielectric covering 60. Dielectric covering 60 is surrounded by a foil 62 and a metallic braid 64. Braid 64 is covered by an outer covering or jacket 66, which may be plastic or any other insulating material. To prepare coaxial cable 56 for use with a coaxial cable connector, cable 56 may be stripped using a wire stripper. As shown in FIG. 1B, a portion of center conductor 58 is exposed by removing a portion of the dielectric covering 60. Foil 62 may remain covering the dielectric layer 60. Metallic braid 64 may then be folded back over onto jacket 66 to overlap with jacket 66. The overlapping portion may extend partially up the length of jacket 66.

FIG. 1C is a cross-sectional drawing of an exemplary rear portion of coaxial cable connector 110 in an unattached configuration. As shown in FIG. 1C, in addition to body 112 and locking sleeve 114, connector 110 may include a post 116. FIG. 1C also shows a coaxial cable 56 being inserted into connector 110, e.g., moved forward in the direction of arrow A. Post 116 may include an annular barb 142 that, as cable 56 is moved forward, is forced between dielectric layer 60 and braid 64. Barb 142 may also facilitate expansion of jacket 66 of cable 56. Locking sleeve 114 may then be moved forward (e.g., in direction A) into connector body 112 to clamp cable jacket 66 against barb 142, providing cable retention. One or more embodiments disclosed herein may allow for easier installation of a connector onto a coaxial cable by, for example, allowing for a smaller barb. One or more embodiments disclosed herein may also provide a seal (e.g., a water-tight seal) between the coaxial cable and portions of the connector, such as between the coaxial cable and the locking sleeve. Further, one or more embodiments disclosed herein may also provide a seal (e.g., a water-tight seal) between the locking sleeve and the connector body.

FIGS. 1D and 1E are cross-sectional drawings of an exemplary forward portion of coaxial cable connector 110 in which coaxial cable 56 has been secured. FIGS. 1D and 1E show cross sections of rotatable nut 118, connector body 112, and tubular post 116 so as to reveal coaxial cable 56 (e.g., dielectric covering 60 and center conductor 58 of coaxial cable 56 are exposed for viewing). FIG. 1D shows dielectric covering 60 and center conductor 58 properly secured in connector 110. In particular, as shown in FIG. 1D, the end surface 142 of dielectric covering 60 is in the same plane as the front surface 140 of a front flange 138 of post 116.

Once coaxial cable 56 is secured in connector 110, connector 110 may then be attached to a port connector of an external device. FIG. 1F shows a cross-sectional drawing of a port connector 48 to which connector 110 may be connected. As illustrated in FIG. 1F, port connector 48 may include a substantially cylindrical body 50 having external threads 52 that match internal threads 154 of rotatable nut 118. In the configuration shown in FIG. 1D, rotatable threaded engagement between threads 154 of nut 118 and threads 52 of port connector 48 may cause rearward surface 53 of port connector 48 to engage front surface 140 of flange 138 of post 116. The conductive nature of post 116 may provide an electrical path from surface 53 of port connector 48 to braid 64 around coaxial cable 56, providing proper grounding and shielding.

FIG. 1E also shows dielectric covering 60 and center conductor 58 secured to connector 110. As shown in FIG. 1E, the end 142 of dielectric covering 60 protrudes a distance d1 beyond the front surface 140 of front flange 138 of post 116. When dielectric covering 60 is in the position shown in FIG. 1E, when connector 110 is connected to an appliance port (e.g., port 48), front surface 140 of flange 138 of post 116 may not come into contact with the end of the appliance port, which may result in improper grounding of braid 64, for example. This position of cable 56 may be referred to as “pistoning” of cable 56, a position which an operator may wish to avoid.

Pistoning can result, for example, when locking sleeve 114 takes hold of (e.g., grips) cable 56 before locking sleeve 114 is fully advanced into body 112 of connector 110. In this situation, the forward movement of locking sleeve 114 pushes dielectric covering 60 beyond front surface 140 of front flange 138. One or more embodiments disclosed herein may help eliminate pistoning of coaxial cables in connectors while securely terminating the coaxial cables in connectors. One reason a locking sleeve may grip cable 56 prematurely is because of the size of barb 142 at the end of post 116, which in combination with locking sleeve 114, may compress and grip jacket 66 between barb 142 and locking sleeve 114 before locking sleeve 114 is fully advanced into body 112. One or more embodiments disclosed herein may help eliminate pistoning of coaxial cables by, for example, allowing for a smaller barb, as mentioned above.

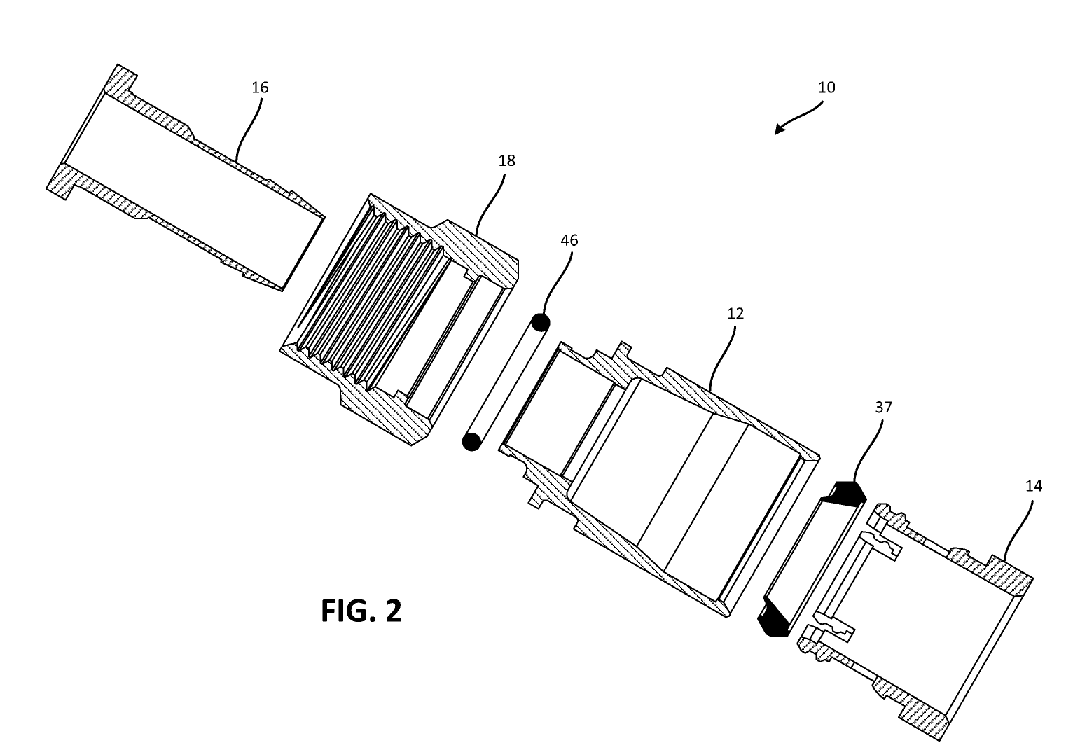

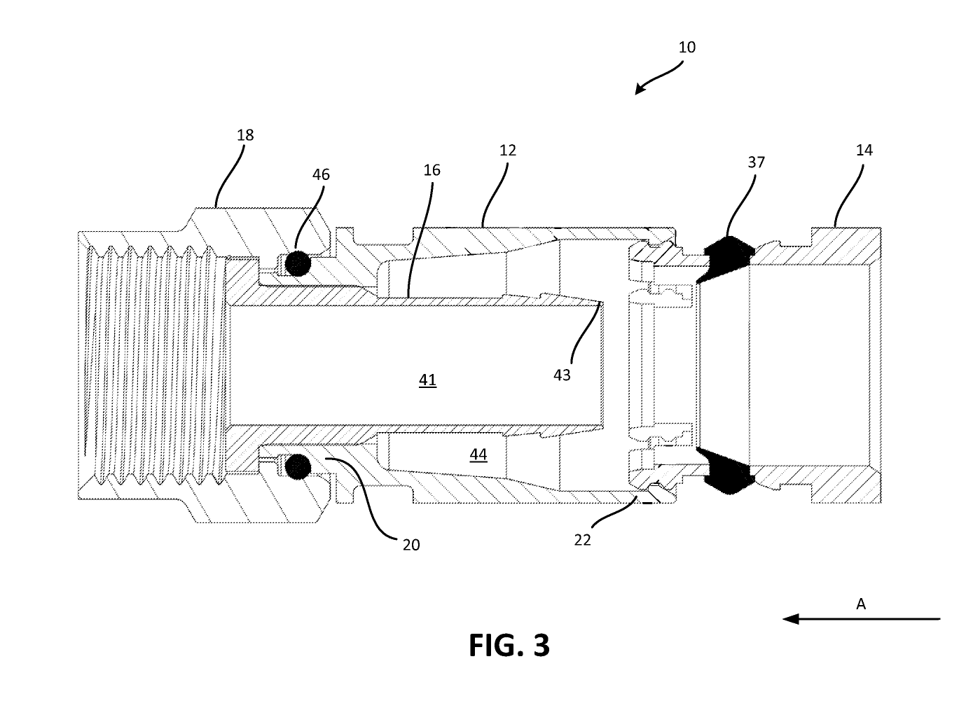

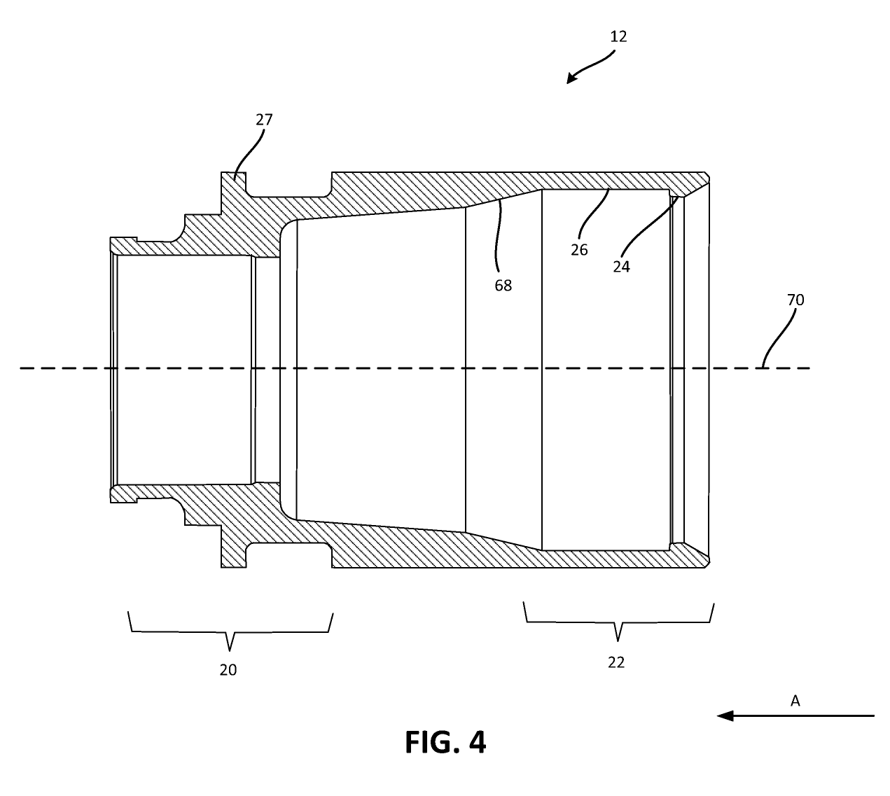

FIG. 2 is an exploded cross-sectional drawing of unassembled components of an exemplary coaxial cable connector 10. As shown in FIG. 2, connector 10 may include a nut 18, a body 12, a locking sleeve 14, a post 16, an O-ring 46, and a seal 37. FIG. 3 is a cross-sectional drawing of coaxial cable connector 10 of FIG. 2 in an assembled, but unconnected configuration (e.g., unconnected from a coaxial cable and/or an appliance port). As shown in FIG. 3, forward end 20 of connector body 12 may be coupled to post 16 (e.g., an annular post) and nut 18. Further, rear end 22 of connector body 12 may be coupled to locking sleeve 14. For ease of illustration, connector body 12, post 16, and nut 18 are enlarged and shown separately in FIGS. 4, 5, and 6, respectively.

FIG. 4 is a cross-sectional drawing of connector body 12. Connector body 12 may include an elongated, cylindrical member, which can be made from plastic, metal, or any suitable material or combination of materials. Connector body 12 may include a forward end 20 and a rear end 22 opposite forward end 20. Rear end 22 may also be referred to as “cable receiving end 22.” Forward end 20 may include a radially extending flange 27. Rear end 22 may include an inner sleeve-engagement surface 24 and a groove or recess 26. In one embodiment, sleeve-engagement surface 24 may include a forward-facing perpendicular wall and a rearward-facing chamfered wall.

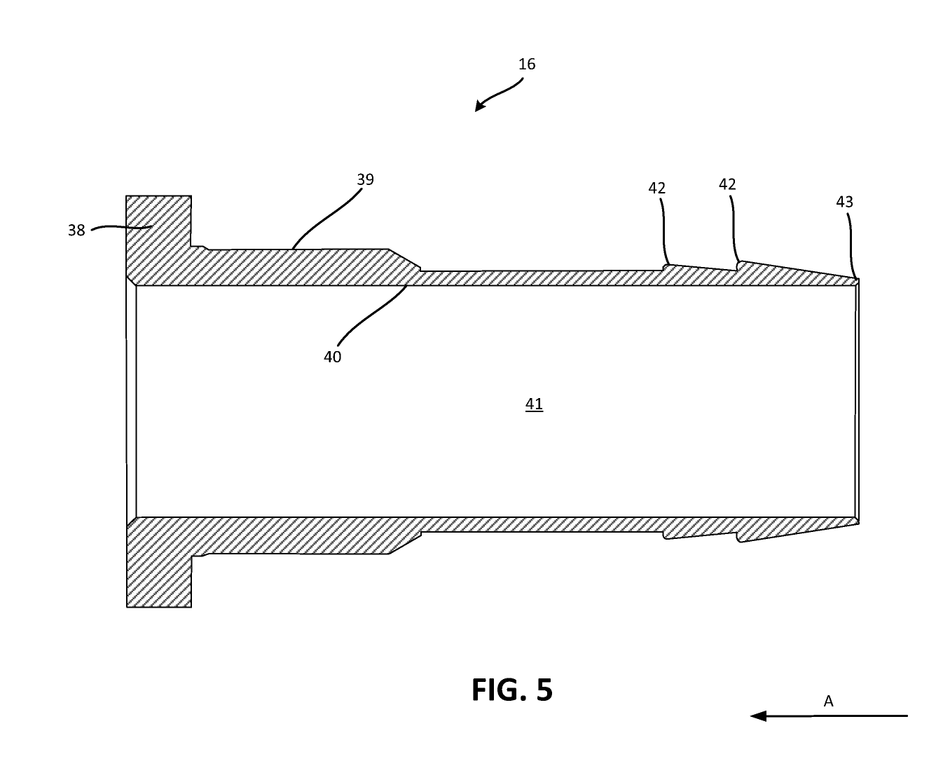

FIG. 5 is a cross-sectional drawing of post 16. Post 16 may include a flanged base portion 38 at its forward end. Post 16 may also include an annular tubular extension 40 extending rearwardly. Post 16 defines a chamber 41 that may receive the center conductor and dielectric covering of an inserted coaxial cable. Tubular extension 40 includes an external surface portion 39 and may include one or more barbs 42 (e.g., radially, outwardly extending ramped flange portions). Post 16 may also include a rear edge 43 that may be inserted between and may separate the dielectric layer and foil from the braid and jacket of a coaxial cable.

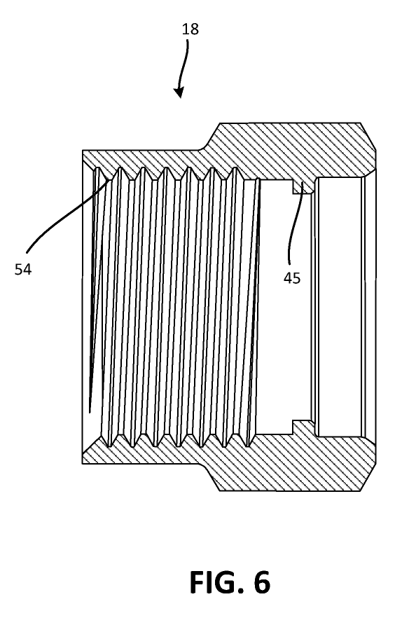

FIG. 6 is a cross-sectional drawing of nut 18. Nut 18 may include internal threads 54 and an internal annular flange 45. Nut 18 may provide mechanical attachment of connector 10 to an external device, e.g., port connector 48 (see FIG. 1F), via a threaded relationship. Rotatable threaded engagement between threads 54 of nut 18 and threads 52 of port connector 48 may cause rearward surface 53 of port connector 48 to engage flange 38 of post 16. The conductive nature of post 16 may provide an electrical path surface 53 of port connector 48 to braid 64 around coaxial cable 56. Nut 18 may include any type of attaching mechanisms, including a hex nut, a knurled nut, a wing nut, or any other known attaching means.

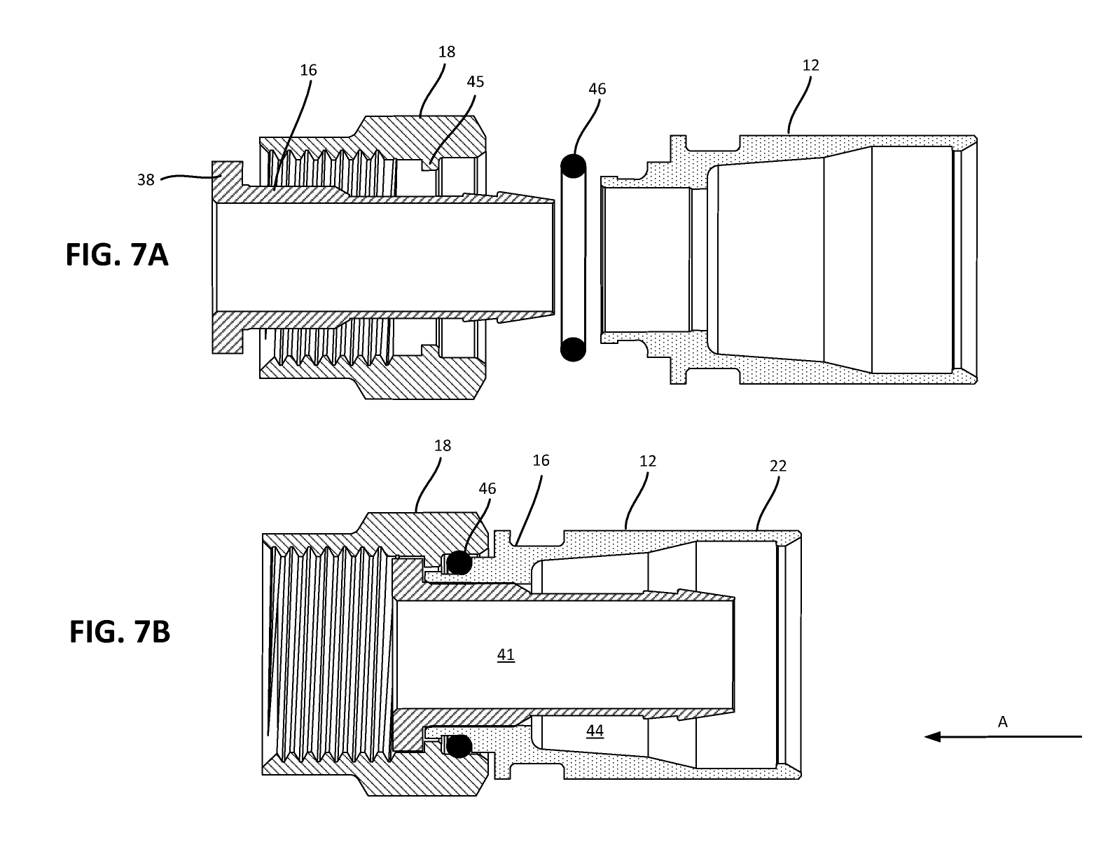

The relationship between forward end 20 of connector body 12, post 16, and nut 18 is described with respect to FIGS. 7A and 7B, which show additional cross-sectional drawings of connector body 12, post 16, and nut 18. As illustrated in FIG. 7B, external surface portion 39 of post 16 may be secured into body 12 with an interference fit. Tubular extension 40 of post 16 may extend rearwardly within body 12 and terminate adjacent rearward end 22 of connector body 12. As illustrated in FIGS. 7A and 7B, post 16 may secure nut 18 by capturing flange 45 of nut 18 between radially extending flange 27 of body 12 and flanged base portion 38 of post 16. In the configuration shown in FIG. 7B, nut 18 may be rotatably secured to post 16 and connector body 12.

Tubular extension 40 of post 16 and connector body 12 define an annular chamber 44, as shown in FIG. 7B, for accommodating the jacket and shield of an inserted coaxial cable. As mentioned above and also shown in FIG. 7B, post 16 defines a chamber 41 that may receive center conductor 58 and dielectric covering 60 of an inserted coaxial cable. As shown in FIGS. 7A and 7B, in one embodiment an O-ring 46 may be positioned within annular nut 18 and between annular nut 18 and body 12. O-ring 46 may include resilient material to provide a seal (e.g., a water-resistant seal) between connector body 12, nut 18, and post 16.

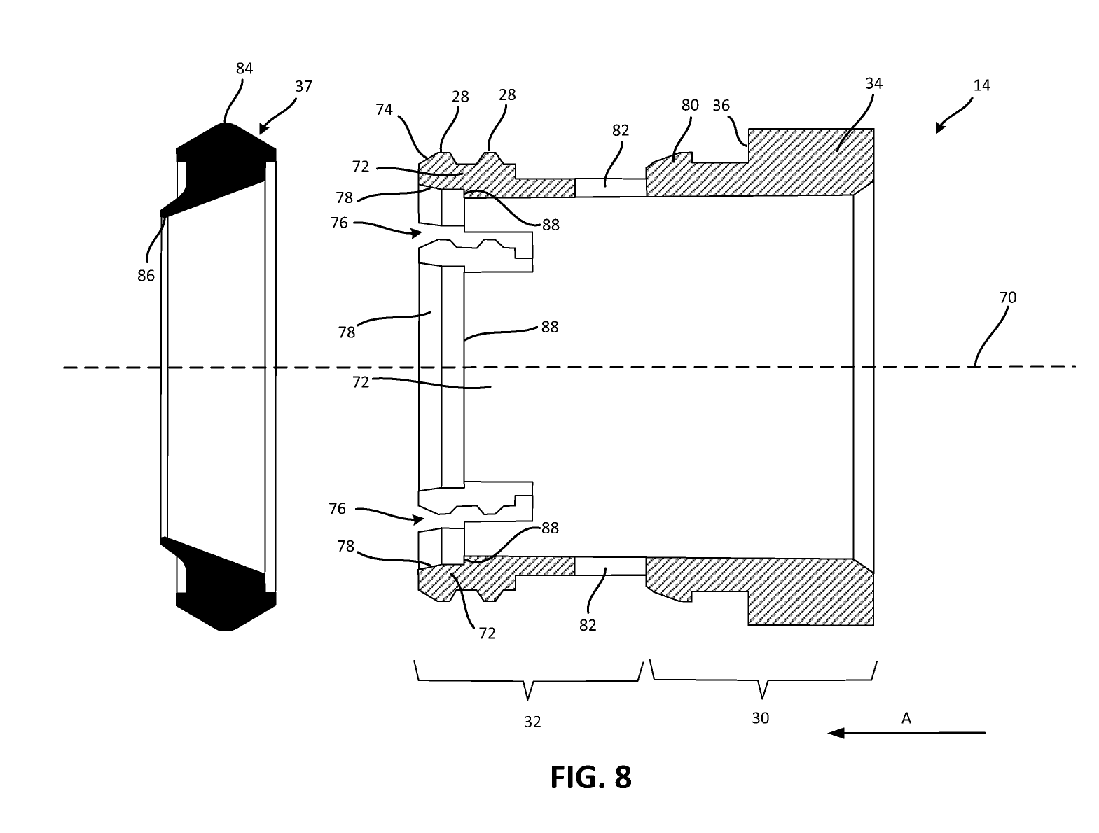

Returning to FIG. 3, as mentioned above, rear end 22 of connector body 12 may be coupled to locking sleeve 14. For ease of illustration, locking sleeve 14 is enlarged and shown separately in FIG. 8, which is a cross-sectional drawing of locking sleeve 14. As shown in FIG. 8, locking sleeve 14 may include a substantially tubular body having a rearward cable receiving end 30 and an opposite forward connector insertion end 32. The outer surface of connector insertion end 32 may include a plurality of ridges, projections, or detent structures 28. In one embodiment, detent structures 28 may include chamfered walls and together may form a groove. Locking sleeve 14 may include a flanged head portion 34 disposed at cable receiving end 30. Head portion 34 may include a forward facing perpendicular wall 36. Head portion 34 may also include an outer diameter larger than an inner diameter of the body 12. Further, locking sleeve 14 may also include an annular rim 80 on the outer surface of sleeve 14. In one embodiment, rim 80 may include a rear-facing perpendicular wall and a forward-facing chamfered wall. Locking sleeve 14 may be formed of resilient material, for example, such as a synthetic plastic (e.g., an acetate resin).

Locking sleeve 14 may also include a number of holes 82 around its tubular body. Holes 82 may secure seal 37 to locking sleeve 14. In one embodiment, seal 37 may be integrated into sleeve 14. For example, seal 37 may be molded (e.g., over molded) to sleeve 14. Seal 37 may include an innermost surface 86 and an outermost surface 84. In one embodiment, outermost surface is 0.408 to 0.412 in. (e.g., 0.410 in.) from central axis 70. In one embodiment, innermost surface 86 is 0.258 to 0.262 in. (e.g., 0.260 in.) from central axis 70. Seal 37 may be resilient enough that inner surface 86 does not break apart upon insertion of a coaxial cable, but soft enough to allow easy insertion of a coaxial cable, while maintaining a seal between sleeve 14 and a coaxial cable and/or body 12. In one embodiment, the Durometer of seal 37 is between 60 and 70 (Shore A scale). In one embodiment, seal 37 may be formed of any resilient material, such as synthetic rubber, an elastomeric polymer, or deformable plastic.

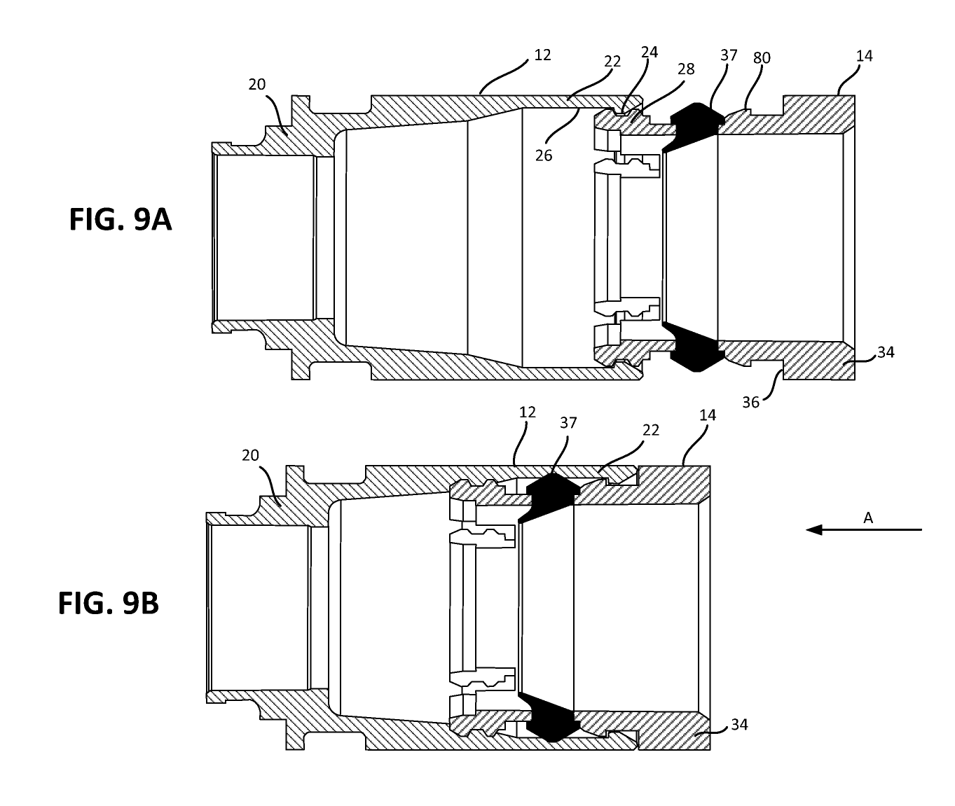

The relationship between rear end 22 of connector body 12 and locking sleeve 14 is described with respect to FIGS. 9A and 9B, which show additional cross-sectional drawings of connector body 12 and locking sleeve 14. As mentioned above, connector body 12 includes sleeve-engagement surface 24 and groove 26. The outer diameter of insertion end 32 of sleeve 14 may be sized to allow the sleeve 14 to be inserted into rear end 22 of body 12. As shown in FIG. 9A, locking sleeve 14 may be coupled to sleeve-engagement surface 24 of connector body 12. In particular, detent structures 28 of locking sleeve 14 may cooperate with surface 24 and groove 26 to couple sleeve 14 to body 12. In one embodiment, in the configuration shown in FIG. 9A, sleeve 14 may be loosely retained in body 12 such that sleeve 14 may be removed by hand from body 12 by an operator and then replaced. Removal and replacement of sleeve 14 may be facilitated, for example, by the chamfered walls of detent structures 28 of sleeve 14 and the chamfered wall of sleeve engagement surface 24 of connector body 12.

Sleeve-engagement surface 24 and groove or recess 26 may cooperate with projections 28 such that locking sleeve 14 may be axially moved in forward direction A from the configuration shown in FIG. 9A to the configuration shown in FIG. 9B. This movement may be facilitated, for example, by the chamfered walls of detent structures 28 of sleeve 14 and the chamfered wall of sleeve engagement surface 24 of connector body 12. Because head portion 34 may include an outer diameter larger than an inner diameter of the body 12, as shown in FIG. 9B, perpendicular wall 36 may serve as an abutment surface against which rear end 22 of body 12 stops to prevent further insertion of locking sleeve 14 into body 12. Further, rim 80 on the outer surface of sleeve 14 may cooperate with protrusion 24 to form a detent locking structure between sleeve 14 and body 12. Thus, in the configuration shown in FIG. 9B, locking sleeve 14 may be secured within connector body 12.

Also, as shown in FIG. 9B, seal 37 may be compressed between sleeve 14 and body 12. Seal 37 may provide a seal (e.g., a water-tight seal) between body 12 and sleeve 14. In one embodiment, an O-ring (not shown) may be provided at forward facing perpendicular wall 36 to provide a seal (e.g., a water-tight seal) between locking sleeve 14 and connector body 12.

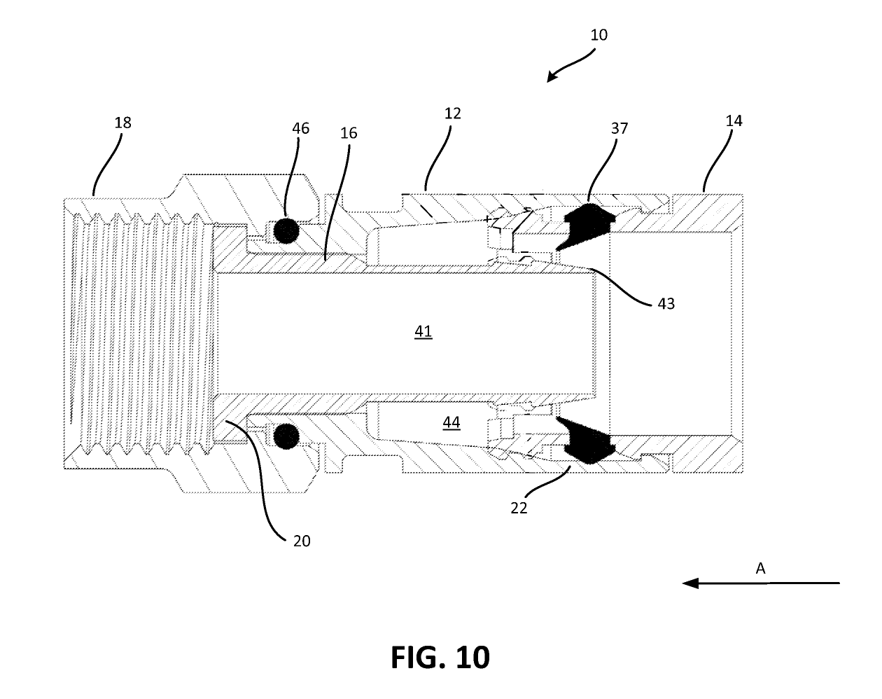

The configuration shown in FIG. 9B is also shown in FIG. 10, which is a cross-sectional drawing of connector 10 in a locked configuration. FIG. 10, however, also shows nut 18, post 16, o-ring 46, and seal 37 in relation to body 12 and locking sleeve 14.

Connector 10 may be supplied in the assembled condition, as shown in FIG. 3. In this assembled condition, connector 10 may be used to terminate a coaxial cable. For example, coaxial cable 56 may be inserted through rearward cable receiving end 30 of locking sleeve 14 to engage post 16. In another embodiment, locking sleeve 14 may first be removed from body 12 and slipped over the end of coaxial cable 56. In this embodiment, cable 56 (together with locking sleeve 14) may subsequently be inserted into rearward end 22 of connector body 12.

In either embodiment, the prepared end of coaxial cable 56 is inserted into connector body 12 and jacket 66 may be separated from dielectric covering 60 by edge 43 of post 16. Post 16 may be incorporated into coaxial cable 56 between cable foil 62 and cable braid 64. Referring to FIG. 3, chamber 41 receives center conductor 58 and dielectric covering 60 of the inserted coaxial cable 56. Further, chamber 44 receives jacket 66 and braid 64 of the inserted coaxial cable 56. Locking sleeve 14 may be moved axially forward in direction A from a first position shown in FIG. 9A (and FIG. 3) to a second position shown in FIG. 9B (and FIG. 10). A compression tool may be used to advance locking sleeve 14 from the first position to the second position. As locking sleeve 14 moves axially forward in direction A, cable jacket 66 may be compressed within chamber 44 to secure cable 56 in connector 10. In one embodiment, barbs 42 may enhance the compression of outer jacket 66 to secure coaxial cable 56 within connector 10. Once cable 56 is secured, connector 10 is ready for attachment to a port connector, such as port connector 48 (see FIG. 1F).

Additional features of the relationship between connector body 12 and locking sleeve 14 are described below with respect to FIGS. 4, 8, 11, and 12. Returning to FIG. 4, the inside surface of body 12 includes an inner ramped wall 68. The surface of ramped wall 68 may approach the central axis of body 12 as ramped wall 68 progress from the rear to the front of body 12. In other words, ramp wall 68 may be cone shaped. In one embodiment, inner ramped wall 68 may include a ramp that is 12 to 14 degrees (e.g., 13 degrees) off central axis 70.

Returning to FIG. 8, locking sleeve 14 may include a plurality of resilient tabs 72 positioned around front portion 32 of sleeve 14. Tabs 72 may be formed by providing longitudinal slots 76 at front portion 32 of sleeve 14. Tabs 72 may include beveled portions 74 (outer bevels 74) on the outer surface of sleeve 14 and beveled portions 78 (inner bevels 78) on the inner surface of sleeve 14. In one embodiment, inner bevels 78 are between 10 to 12 degrees (e.g., 11 degrees) off central axis 70. Tabs 72 also include detent structures 28, discussed above with respect to FIGS. 9A and 9B. In one embodiment, the outermost diameter of detent structures 28 is between 0.393 in. and 0.397 in. (e.g., 0.395 in.). Thus, in this embodiment, the diameter of ramp wall 68 at its widest point (its rearmost point) may be slightly larger than (or approximately equal to) 0.393 in. to 0.397 in. (e.g., slightly larger than or equal to 0.395 in.). Tabs 72 may also include ridges or tooth/teeth 88 on the inner surface of tabs 72. In one embodiment, teeth 88 form ninety degree angles.

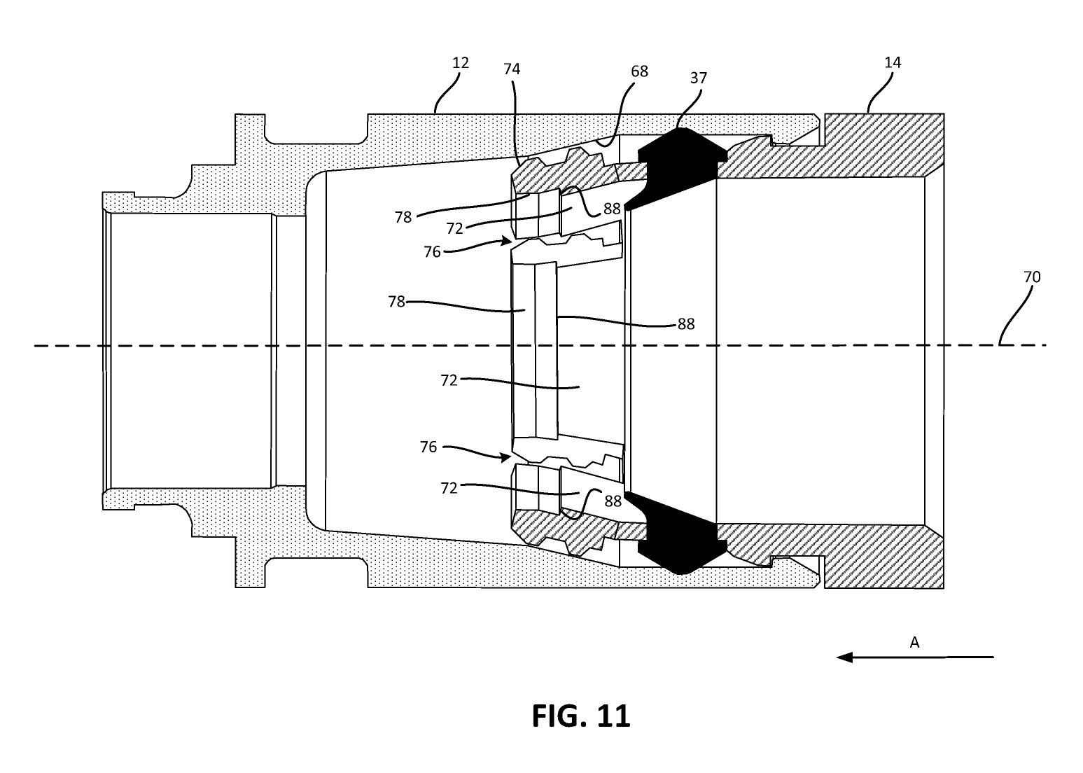

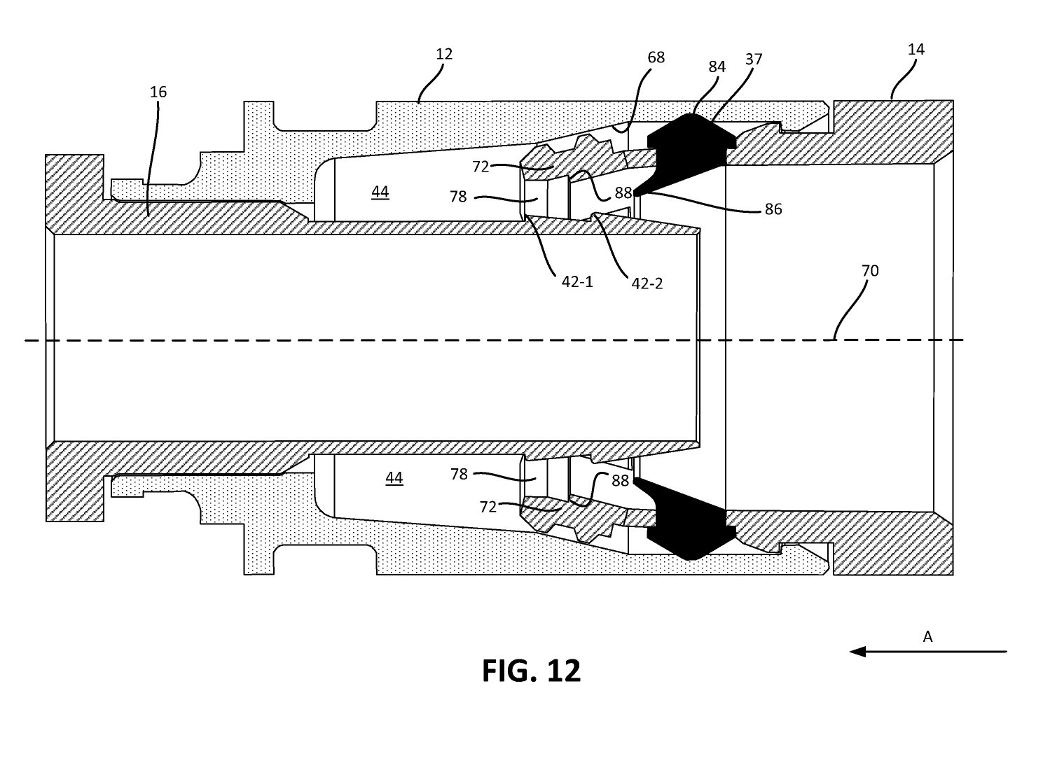

FIG. 11 is an additional cross-sectional drawing of connector body 12 and locking sleeve 14 showing the relationship between the two when sleeve 14 is in a locked position. FIG. 12 is an additional cross-sectional drawing of connector body 12, locking sleeve 14, and post 16 showing the relationship between the three when sleeve 14 is in a locked position. As shown in FIGS. 11, when sleeve 14 is inserted into body 12 (e.g., from the position shown in FIG. 9A to the position shown in FIG. 9B), outer bevels 74 of tabs 72 may contact ramped wall 68 of body 12. Ramped wall 68 may deflect tabs 72 inward towards center axis 70 of sleeve 14. As shown in FIG. 12, the deflection of tabs 72 inward may act to compresses jacket 66 between tabs 72 and post 16, thus helping to secure cable 56 to connector 10.

As also shown in FIGS. 11 and 12, the deflection of tabs 72 inward may act to change the orientation and/or position of inner bevels 78. In one embodiment, outer bevels 74, protrusions 28, and ramped wall 68 cooperate such that the surfaces of inner bevels 78 become substantially parallel to center axis 70 (e.g., parallel to the outer surface of jacket 66) when sleeve 14 is in the configuration of FIGS. 11 and 12 Inner bevels 78 being substantially parallel to center axis 70 may help prevent cable pistoning, described above.

As also shown in FIG. 12, the deflection of tabs 72 inward may act to move teeth 88 toward post 16. In this embodiment, teeth 88 may compress jacket 66 between post 16 and tabs 72. In addition, teeth 88 may compress jacket 66 at the point on post 16 between barbs 42 (e.g., between the first, rear barb 42 and the second, forward barb 42). In this embodiment, first barb 42-1 may be between 0.111 in. to 0.113 in. (e.g., 0.112 in.) away from central axis 70 and second barb 42-2 may be between 0.114 in. to 0.116 in. (e.g., 0.115 in.) away from central axis 70.

Also, as shown in FIGS. 11 and 12, seal 37 may be compressed between sleeve 14 and body 12. As discussed above, seal 37 may provide a seal (e.g., a water-tight seal) between body 12 and sleeve 14. As shown in FIG. 12, inner surface 86 of seal 37 resides between sleeve 14 and post 16 where jacket 66 of cable 56 also resides. Thus, seal 37 may provide a seal (e.g., a water-tight seal) between sleeve 14 and cable 56.

The foregoing description of exemplary embodiments provides illustration and description, but is not intended to be exhaustive or to limit the embodiments described herein to the precise form disclosed. Modifications and variations are possible in light of the above teachings or may be acquired from practice of the embodiments.

For example, seal 37 may take on various different shapes. In one embodiment, the portion of seal 37 inside sleeve 14 may take the same shape as the portion of seal 37 outside sleeve 14. Further, although the forward direction is the direction labeled by arrow A, this direction is relative and could be labeled as any direction.

As another example, various features have been mainly described above with respect to a coaxial cables and connectors for securing coaxial cables. In other embodiments, features described herein may be implemented in relation to other types of cable or interface technologies. For example, the coaxial cable connector described herein may be used or usable with various types of coaxial cable, such as 50, 75, or 93 ohm coaxial cable, or other characteristic impedance cable designs.

Although the invention has been described in detail above, it is expressly understood that it will be apparent to persons skilled in the relevant art that the invention may be modified without departing from the spirit of the invention. Various changes of form, design, or arrangement may be made to the invention without departing from the spirit and scope of the invention. Therefore, the above mentioned description is to be considered exemplary, rather than limiting, and the true scope of the invention is that defined in the following claims.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

What is claimed is:

1. A coaxial cable connector for coupling a coaxial cable to a mating connector, the coaxial cable connector comprising:
a connector body having a forward end and a rearward cable receiving end for receiving a cable;
a nut rotatably coupled to the forward end of the connector body;
an annular post disposed within the connector body, the annular post including an inner chamber extending axially therethrough and a first barb and a second barb;
a locking sleeve including a chamber extending therethrough, a first end coupled to the connector body, a second end for receiving the cable, and at least one tooth;
wherein the locking sleeve is configured so that when the locking sleeve is moved axially into the connector body, the at least one tooth is configured to compress the cable between the first barb and the second barb.

2. The coaxial cable connector of claim 1,
wherein the first end of the locking sleeve includes a plurality of tabs, and wherein each tab includes a tooth, wherein each tooth is configured so that when the locking sleeve is moved axially into the connector body, each tooth compresses the cable between the first barb and the second barb.

3. The coaxial cable connector of claim 2, wherein each tab includes an inner surface, wherein each tab is configured so that when the locking sleeve is moved axially into the connector body, each tab is deflected inward such that the inner surface of the tab is parallel to a central axis of the coaxial cable connector.

4. The coaxial cable connector of claim 3, wherein the connector body includes a ramped wall that deflects each tab inward.

5. The coaxial cable connector of claim 1, wherein the locking sleeve includes an inner surface and an inner sealing ring disposed on the inner surface of the locking sleeve to provide a seal between a jacket of the cable and the locking sleeve.

6. The coaxial cable connector of claim 5, wherein the locking sleeve includes an outer surface and an outer sealing ring disposed on the outer surface of the locking sleeve to provide a seal between the locking sleeve and the connector body when the locking sleeve is moved axially into the connector body.

7. The coaxial cable connector of claim 6, wherein the inner sealing ring and the outer sealing ring are integrally formed.

8. The coaxial cable connector of claim 6, wherein the outer sealing ring is overmolded on the locking sleeve.

9. A coaxial cable connector for coupling a coaxial cable to a mating connector, the coaxial cable connector comprising:
a connector body having a forward end and a rearward cable receiving end for receiving a cable;
a nut rotatably coupled to the forward end of the connector body;
an annular post disposed within the connector body, the annular post including an inner chamber extending axially therethrough;
a locking sleeve including a chamber extending therethrough, a first end coupled to the connector body, a second end for receiving the cable, and
wherein the first end of the locking sleeve includes a plurality of tabs, wherein each tab includes an inner surface, wherein each tab is configured so that when the locking sleeve is moved axially into the connector body, each tab is deflected inward such that the inner surface of the tab is parallel to a central axis of the coaxial cable connector.

10. The coaxial cable connector of claim 9, wherein each tab is configured so that when the locking sleeve is moved axially into the connector body, each tab compresses the cable.

11. The coaxial cable connector of claim 9,
wherein the post includes a first barb and a second barb,
wherein the locking sleeve is configured so that when the locking sleeve is moved axially into the connector body, the at least one tooth is configured to compress the cable between the first barb and the second barb.

12. The coaxial cable connector of claim 11,
wherein each tab includes a tooth, wherein each tooth is configured so that when the locking sleeve is moved axially into the connector body, each tooth compresses the cable between the first barb and the second barb.

13. The coaxial cable connector of claim 9, wherein the connector body includes a ramped wall that deflects each tab inward.

14. The coaxial cable connector of claim 9, wherein the locking sleeve includes an inner surface and an inner sealing ring disposed about the inner surface of the locking sleeve to provide a seal between a jacket of the cable and the locking sleeve.

15. The coaxial cable connector of claim 14, wherein the locking sleeve includes an outer surface and an outer sealing ring disposed on the outer surface of the locking sleeve to provide a seal between the locking sleeve and the connector body when the locking sleeve is moved axially into the connector body.

16. The coaxial cable connector of claim 15, wherein the inner sealing ring and the outer sealing ring are integrally formed.

17. The coaxial cable connector of claim 15, wherein the outer sealing ring is overmolded on the locking sleeve.

18. A coaxial cable connector for coupling a coaxial cable to a mating connector, the coaxial cable connector comprising:
a connector body having a forward end and a rearward cable receiving end for receiving a cable;
a nut rotatably coupled to the forward end of the connector body;
an annular post disposed within the connector body, the annular post including an inner chamber extending axially therethrough;
a locking sleeve including a chamber extending therethrough, a first end coupled to the connector body, a second end for receiving the cable, and
wherein the locking sleeve includes an inner surface and an inner sealing ring disposed about the inner surface of the locking sleeve to provide a seal between a jacket of the cable and the locking sleeve.

19. The coaxial cable connector of claim 18, wherein the locking sleeve includes an outer surface and an outer sealing ring disposed on the outer surface of the locking sleeve to provide a seal between the locking sleeve and the connector body when the locking sleeve is moved axially into the connector body.

20. The coaxial cable connector of claim 19, wherein the inner sealing ring and the outer sealing ring are integrally formed.

21. The coaxial cable connector of claim 19, wherein the outer sealing ring is overmolded on the locking sleeve.

22. The coaxial cable connector of claim 18, wherein the first end of the locking sleeve includes a plurality of tabs, wherein each tab includes an inner surface, wherein each tab is configured so that when the locking sleeve is moved axially into the connector body, each tab is deflected inward such that the inner surface of the tab is parallel to the outer jacket of the cable.

23. The coaxial cable connector of claim 18,
wherein the post includes a first barb and a second barb,
wherein the locking sleeve is configured so that when the locking sleeve is moved axially into the connector body, the at least one tooth is configured to compress the cable between the first barb and the second barb.

24. The coaxial cable connector of claim 23,
wherein the first end of the locking sleeve includes a plurality of tabs, and wherein each tab includes a tooth, wherein each tooth is configured so that when the locking sleeve is moved axially into the connector body, each tooth compresses the cable between the first barb and the second barb.

25. The coaxial cable connector of claim 24, wherein the connector body includes a ramped wall that deflects each tab inward.
